(19) United States
(12) Patent Application Publication
(10) Pub. No.: US 2026/0081652 A1
(43) Pub. Date: Mar. 19, 2026

(54) ANTENNA SELECTION IN IDLE MODE

(71) Applicant: QUALCOMM Incorporated, San Diego, CA (US)

(72) Inventors: Boting WANG, Beijing (CN); Peter Pui Lok ANG, San Diego, CA (US); Mihir NABAR, Hyderabad (IN); Daowei LIN, Shenzhen (CN); Tongxin WANG, Shanghai (CN); Weixian SHEN, San Diego, CA (US); Tangtang WU, Shanghai (CN); Xiaochen CHEN, Beijing (CN); Udayan BHAWNANI, San Diego, CA (US); Tom CHIN, San Diego, CA (US); Zhongyue LOU, Beijing (CN); Scott HOOVER, Del Mar, CA (US); Thawatt GOPAL, San Diego, CA (US)

(21) Appl. No.: 19/109,111

(22) PCT Filed: Oct. 18, 2022
(86) PCT No.: PCT/CN2022/125863

§ 371 Date: Mar. 5, 2025

(51) Int. Cl. H04B 7/06; H04B 7/08

(52) U.S. Cl. CPC H04B 7/0608; H04B 7/0874

(57) ABSTRACT

Method and apparatus for antenna selection in idle mode. The apparatus measures a channel condition for each of a plurality of antennas at a UE. The apparatus dynamically selects, while in a RRC idle mode, at least one antenna from the plurality of antennas based on the channel condition. The apparatus may terminate measurement of the channel condition for each of the plurality of antennas in response to the channel condition on two active antennas being greater than a first threshold T0 and a PDSCH result comprises a CRC pass rate of 100%. The apparatus may trigger a measurement across the plurality of antennas in response to the channel condition across a first pair of active antennas is less than a second threshold (T1). The apparatus may determine whether a second pair of antennas have channel conditions greater than the second threshold.

### TECHNICAL FIELD

The present disclosure relates generally to communication systems, and more particularly, to a configuration for antenna selection in idle mode.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus measures a channel condition for each of a plurality of antennas at the UE. The apparatus dynamically selects, while in a radio resource control (RRC) idle mode, at least one antenna from the plurality of antennas based on the channel condition.

In an aspect of the disclosure, a method, a computer-readable medium, and an apparatus are provided. The apparatus may be a device at a UE. The device may be a processor and/or a modem at a UE or the UE itself. The apparatus measures a channel condition for a first set of antennas and a second set of antennas at the UE. The apparatus dynamically selects, while in a radio resource control (RRC) idle mode, at least one antenna from the first set of antennas or the second set of antennas based on the channel condition

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an example diagram of dynamic antenna selection in RRC idle mode.

FIG. 5 is an example diagram of dynamic antenna selection in RRC idle mode.

FIG. 6 is a call flow diagram of signaling between a UE and a base station.

FIG. 7 is a flowchart of a method of wireless communication.

FIG. 8 is a flowchart of a method of wireless communication.

FIG. 9 is a diagram illustrating an example of a hardware implementation for an example apparatus and/or network entity.

FIG. 10 is a call flow diagram of signaling between a UE and a base station.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

### DETAILED DESCRIPTION

In wireless communications, when a UE is in a CONNECT state with traffic, a receive diversity and an antenna switch diversity (AsDiv) algorithm may operate when the UE hardware supports 4 antennas. However, when the UE is in an RRC idle mode, the hardware may only support an antenna diversity within a default pair, where the default pair may be Rx01. An idle antenna diversity may comprise two states, a first state 1Rx and a second state 2Rx. For the first state 1Rx, either Rx0 or Rx1 may be selected, while for the second state 2Rx, only Rx01 is available. For the UE in the idle state, a current antenna selection may be limited within default Rx01 and may be utilized for idle activities, such as, SIB reading, receiving paging messages, neighbor cell measurements, and the like. In some instances, Rx0 or Rx1 may not be the best performing antennas from all the antennas available at the UE, such that another antenna may have a better signal or may perform better in comparison to Rx0 or Rx1.

Aspects presented herein provide a configuration for antenna selection in idle mode. The configuration may allow a UE to select an antenna while in a RRC idle mode based at least on a channel condition for each of a plurality of antennas at the UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

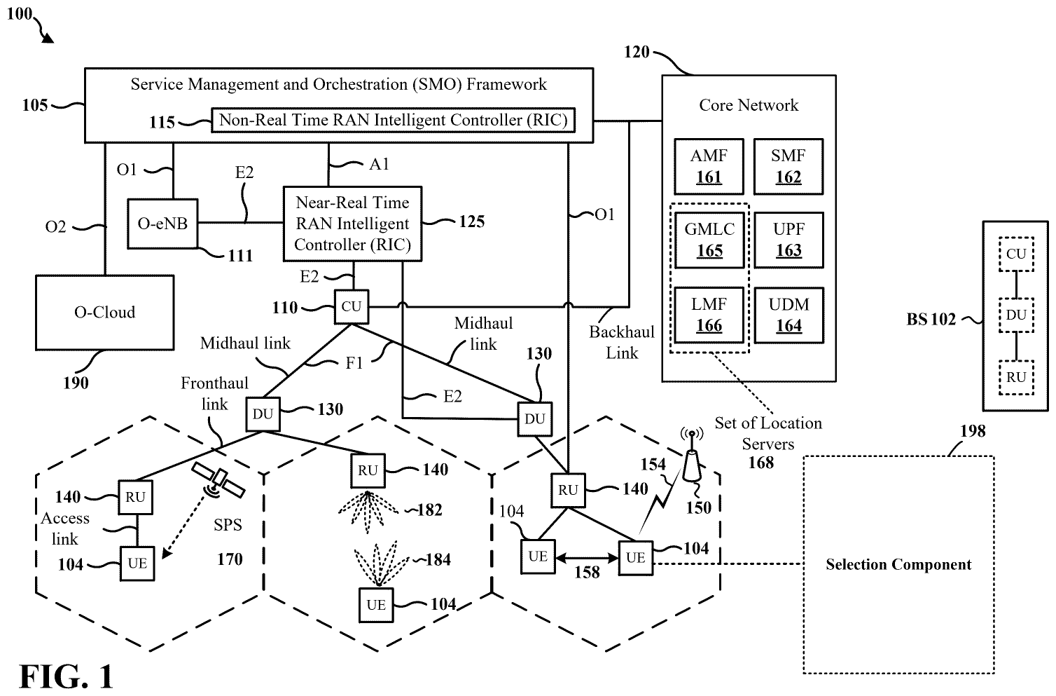

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a selection component 198 configured to measure a channel condition for each of a plurality of antennas at the UE; and dynamically select, while in a radio resource control (RRC) idle mode, at least one antenna from the plurality of antennas based on the channel condition. In certain aspects, the selection component 198 may be configured to measure a channel condition for a first set of antennas and a second set of antennas at the UE; and dynamically select, while in a radio resource control (RRC) idle mode, at least one antenna from the first set of antennas or the second set of antennas based on the channel condition.

Although the following description may be focused on 5G NR, the concepts described herein may be applicable to other similar areas, such as LTE, LTE-A, CDMA, GSM, and other wireless technologies.

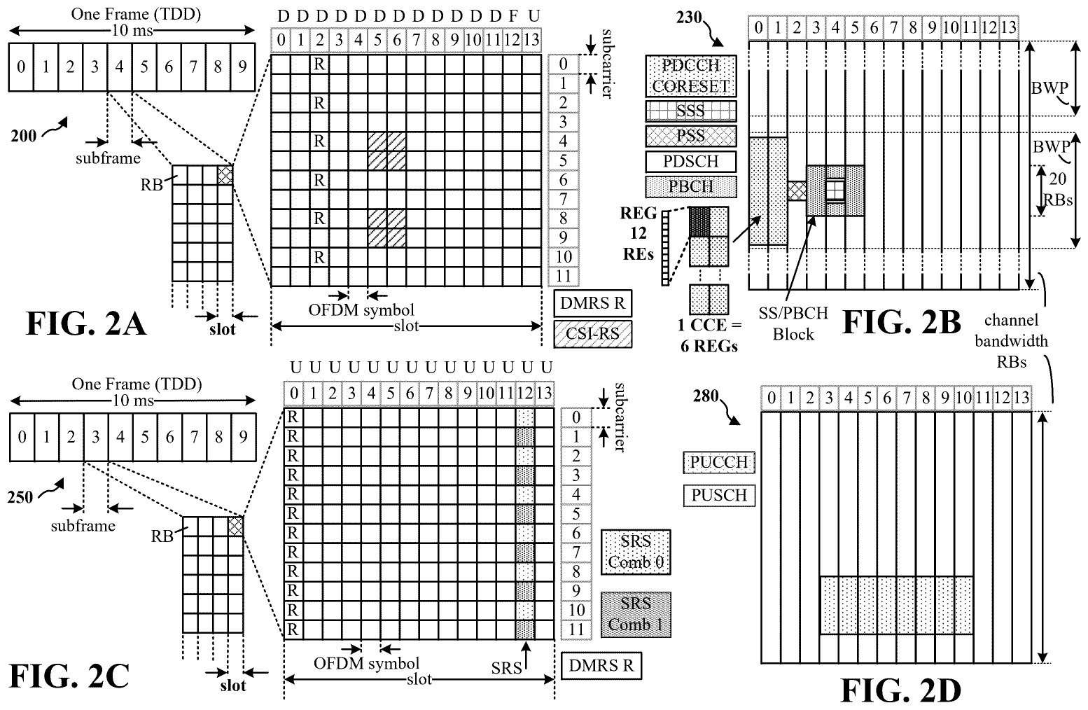

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

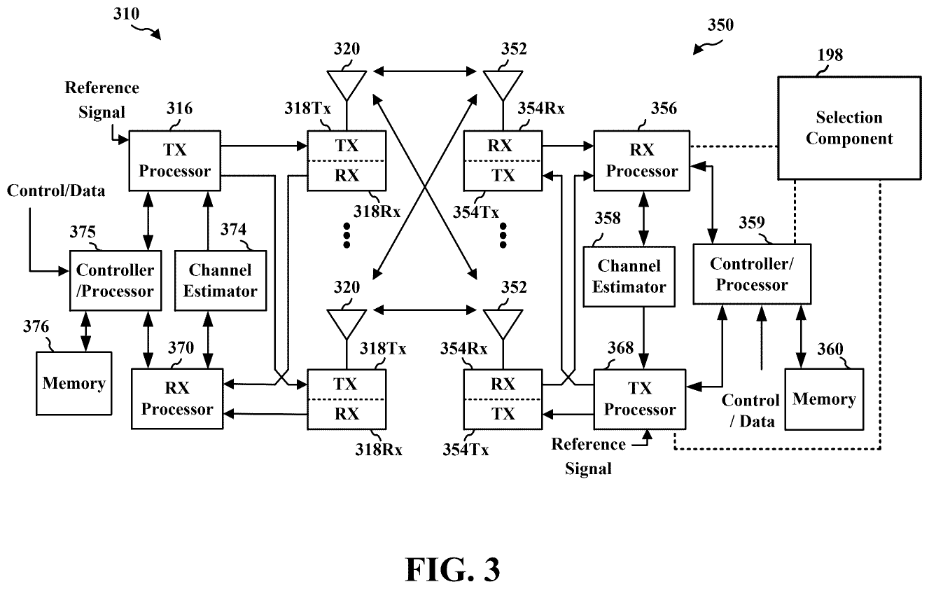

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the selection component 198 of FIG. 1.

In wireless communications, when a UE is in a CONNECT state with traffic, a receive diversity and an AsDiv algorithm may operate when the UE hardware supports 4 antennas. UEs may utilize all possible antenna patterns and maintain the UE performance and power consumption in balance, including downlink and uplink. However, when the UE is in an RRC idle mode, the hardware may only support an antenna diversity within a default pair, where the default pair may be Rx01. An idle antenna diversity may comprise two states, a first state 1Rx and a second state 2Rx. For the first state 1Rx, either Rx0 or Rx1 may be selected, while for the second state 2Rx, only Rx01 is available. For the UE in the idle state, a current antenna selection may be limited within default Rx01 and may be utilized for idle activities, such as, SIB reading, receiving paging messages, neighbor cell measurements, and the like. In some instances, Rx0 or Rx1 may not be the best performing antennas from all the antennas available at the UE, such that another antenna may have a better signal or may perform better in comparison to Rx0 or Rx1. Performance may be degraded for various reasons. For example, one of the antennas may have a poor reference signal received power (RSRP) and/or a poor signal to noise ratio (SNR) due to the antenna being blocked by a user's hand. In some instances, a paging message decode failure may be due to a poor SNR on the default antenna pair, which may result in poor performance or missed calls. In some instances, a SIB decode failure may occur due to a poor SNR, which may lead to an out of service state. In yet some instances, a degraded RSRP may appear to be stable on the default antenna pair, while the poor Rx may remain throughout the entire idle mode, which may lead to unnecessary triggering of reselection due to a poor signal.

Aspects presented herein provide a configuration for antenna selection in idle mode. The configuration may allow a UE to select an antenna while in a RRC idle mode based at least on a channel condition for each of a plurality of antennas at the UE. At least one advantage of the disclosure is that the UE may be configured to obtain channel condition information and support dynamic antenna selection while in the RRC idle mode, which may improve UE performance.

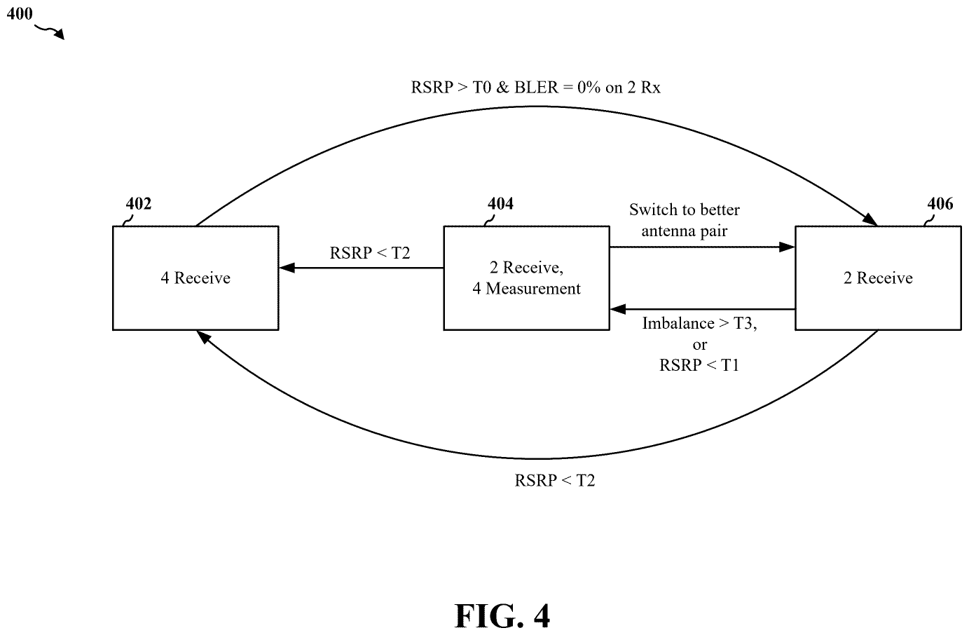

FIG. 4 is a diagram 400 of dynamic antenna selection in RRC idle mode. In some instances, the UE may comprise a plurality of antennas. For example, the UE may comprise 4 antennas, while in some instances, the UE may have more or less than 4 antennas, such that the disclosure is not intended to be limited to the aspects disclosed herein.

The UE may tune all 4 antennas and may trigger a measurement to determine the one or more antennas having the best channel condition or signal quality. In some instances, the UE may perform the measurement to determine the first best antenna, the second best antenna, or the best 4 antennas, where the antennas are ranked based on channel condition or signal quality. The UE may perform the measurement for a measurement period of the antennas (e.g., 4 antennas), where the measurement period may be changed dynamically. The measurement period may be changed dynamically based on power consumption.

In some aspects, if the signal is good on an active pair of antennas (e.g., 2Rx), and the PDSCH result comprises a CRC pass rate of 100%, then the UE may disable the measurement across the four antennas (e.g., 4Rx), such that measurement across the inactive antennas is terminated. The signal may be determined as good on the active pair of antennas if the signal is greater than a first threshold (T0). The first threshold TO may be based on at least one of RSRP, reference signal received quality (RSRQ), or SNR. In such instances, with reference to diagram 400 of FIG. 4, the UE may transition from a first state 402 where 4 antennas are being measured (e.g., active pair of antennas and an inactive pair of antennas), to a second state 406 where 2 antennas are active and measurement across the inactive antennas is terminated based on the RSRP being greater than first threshold T0 and having a CRC pass rate of 100% (e.g., block error rate (BLER) of 0%).

In some aspects, if there is a large imbalance on the active pair of antennas (e.g., 2Rx), then the UE may trigger a measurement across the four antennas (e.g., 4Rx). The imbalance may be determined to be a large imbalance if an imbalance difference (e.g., imbalance delta) between the active pair of antennas is greater than a fourth threshold (T3). The four threshold T3 may be based on at least one of RSRP, RSRQ, or SNR. In such instances, with reference to FIG. 4, the UE may transition from the second state 406 to a third state 404, where 2 antennas are active but measurements occur across all 4 antennas, in response to the active pair of antennas having an imbalance different that is greater than the fourth threshold T3.

In some aspects, if the signal degrades and falls below a second threshold (T1), then the UE may trigger measurements across all 4 antennas to determine if another pair of antennas are better than a current pair of antennas. If the another pair of antennas has a better signal quality than the current pair of antennas, then then UE may switch to the another pair of antennas. For example, the UE may be at the second state 406 and may transition to the third state 404 if the signal quality across a current pair of antennas is less than the second threshold (T1). The second state 404 may comprise 2 antennas as active where measurements occur across all 4 antennas.

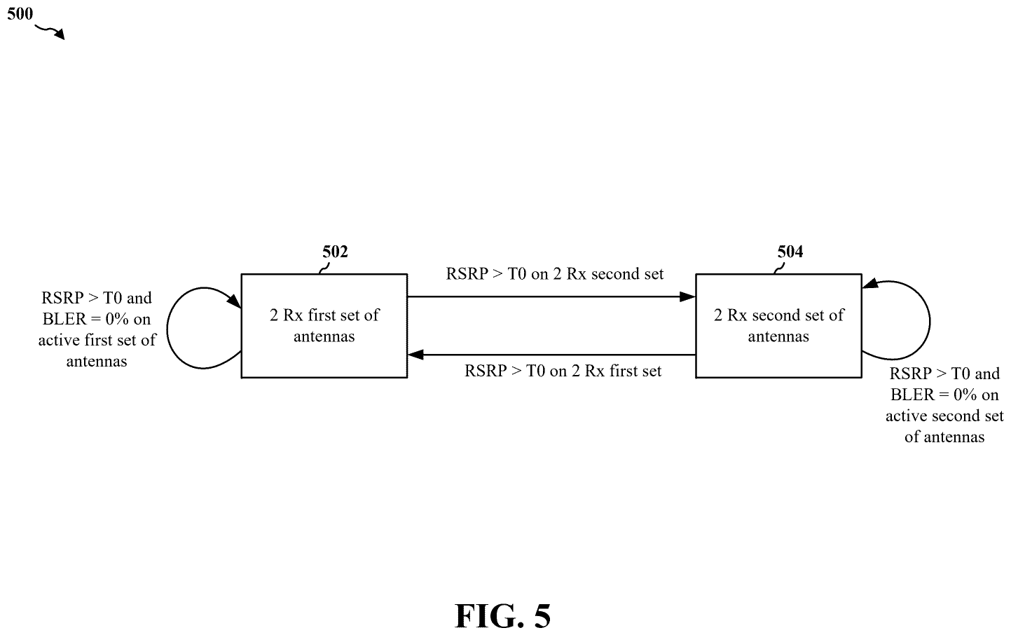

In some aspects, if the signal degrades and falls below a third threshold (T2), then the UE may enable all 4 antennas to receive paging or SIB decoding in an effort to improve downlink receiving performance. For example, the UE may be at the second state 406 or the third state 404, and may transition to the first state 402 if the signal quality falls below the third threshold T2, such that all 4 antennas configured to receive paging or SIB messages to improve downlink receiving performance. FIG. 5 is a diagram 500 of dynamic antenna selection in RRC idle mode. In some instances, the UE may comprise a plurality of sets of antennas. For example, the UE may comprise a first set of antennas and a second set of antennas. In some aspects, each sets of antennas may comprise at least one antenna.

The UE may tune 2 antennas during an evaluation period and perform measurements across the first and second sets. The UE may measure non-active antenna pair so that the UE may dynamically select at least one antenna or antenna pair having the strongest quality from the first or second sets. The selected at least one antenna or antenna pair may be utilized for RRC idle activities.

The antenna measurements may comprise multiple timing options. For example, measurements may be performed on inactive sets of antennas during a discontinuous reception (DRX) off period. In some aspects, the measurement rate may be based on each pair of the first and second sets being triggered once every idle DRX (I-DRX) cycle or multiple I-DRX cycles. This may be defined based on a DRX cycle length configuration or other conditions. The measurement rate may be adaptive based on the active pair of antennas RSRP level. For example, if a second threshold T1 is less than the active pair of antennas RSRP level, but the active pair of antennas RSRP level is less than or equal to a first threshold T0, then the measurement may occur every 4^{th} I-DRX cycle. In some aspects, if a third threshold T2 is less that the active pair of antennas RSRP level, but the active pair of antennas RSRP level is less than or equal to the second threshold T1, then the measurement may occur every 2^{nd} I-DRX cycle. In some aspects, if a fourth threshold T3 is less than an active pair of antennas RSRP level, but the active pair of antennas RSRP level is less than or equal to a third threshold T2, then the measurement may occur every I-DRX cycle.

In some aspects, if the signal of the active pair of antennas is greater than the first threshold T0, and the PDSCH result comprises a CRC pass rate of 100% (e.g., BLER=0%), then the UE does not switch antennas and remains on the active pair. The UE may measure the inactive pair of antennas. For example, with reference to FIG. 5, the UE may be at a first state 502 comprised of 2 antennas of the first set of antennas, and if the signal of the 2 antennas of the first set of antennas is greater than the first threshold T0 and has a BLER of 0%, then the UE remains at the first state 502 and does not switch states. In another example, the UE may be at a second state 504 comprised of 2 antennas of the second set of antennas, and if the signal of the 2 antennas of the second set of antennas is greater than the first threshold T0 and has a BLER of 0%, then the UE remains at the second state 504 and does not switch states. In some aspects, if the signal of either active pair of antennas from the first set or second set of antennas falls below or is equal to a first threshold T0 or PDSCH CRC failures are detected, then the UE may trigger a measurement on the inactive set of antennas and determine if there is a better candidate for antenna selection. For example, with reference to FIG. 5, if the UE is at the first state 502 and has an RSRP that is greater than the first threshold T0 on the second set, then the UE may transition to the second state 504, such that the pair of antennas at the second set of antennas has a better signal than the pair of antennas at the first set of antennas. In another example, with reference to FIG. 5, if the UE is at the second state 504 and has an RSRP that is greater than the first threshold T0 on the first set, then the UE may transition to the first state 502, such that the pair of antennas at the first set of antennas has a better signal than the pair of antennas at the second set of antennas.

In some aspects, the UE may lock one antenna from the first set or the second set of antennas on the best antenna amongst the first and second sets of antennas based on signal strength, such that the first set may comprise one antenna and the second set comprises three antennas. The UE may periodically measure the 3 antennas within the second set to determine the best antenna from within the second set. The UE may then determine the best pair of antennas as the antenna from the first set and the antenna having the strongest or highest quality from the 3 antennas within the second set.

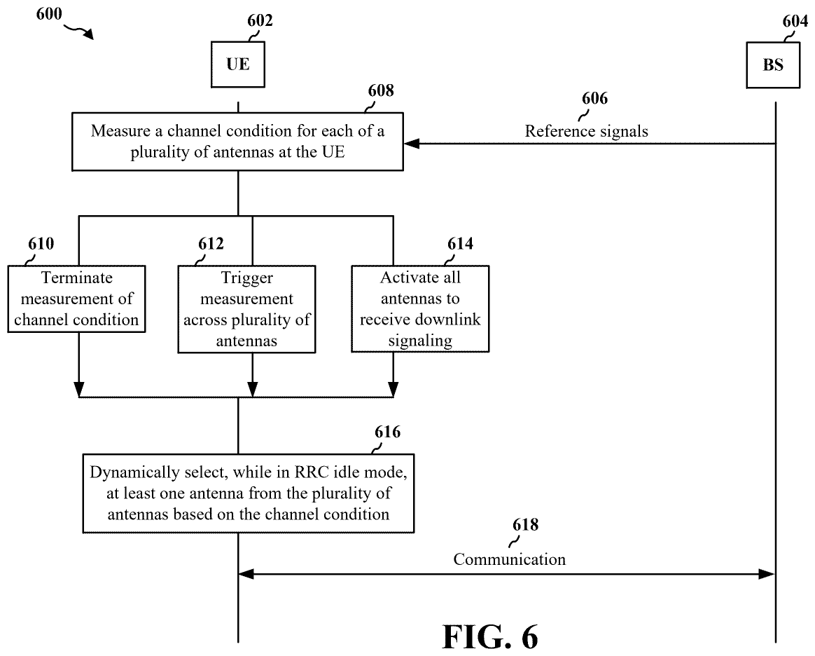

FIG. 6 is a call flow diagram 600 of signaling between a UE 602 and a base station 604. The base station 604 may be configured to provide at least one cell. The UE 602 may be configured to communicate with the base station 604. For example, in the context of FIG. 1, the base station 604 may correspond to base station 102. Further, a UE 602 may correspond to at least UE 104. In another example, in the context of FIG. 3, the base station 604 may correspond to base station 310 and the UE 602 may correspond to UE 350.

At 606, the base station 604 may transmit one or more reference signals to the UE 602. The UE 602, at 608, may measure a channel condition for each of a plurality of antennas at the UE. The UE 602 may measure the channel condition for each of the plurality of antennas at the UE based on the one or more reference signals received from the base station 604. In some aspects, the channel condition for each of the plurality of antennas may be measured during a measurement period. The measurement of the channel condition may be based on at least one threshold. In some aspects, the at least one threshold may be configurable or pre-configured. The UE may measure the channel condition based on any of the aspects described in connection with FIG. 4.

At 610, the UE 602 may terminate the measurement of the channel condition for each of the plurality of inactive antennas at the UE. The UE may terminate the measuring of the channel conditions for each of the plurality of inactive antennas in response to the channel condition on two active antennas, from the plurality of antennas, being greater than a first threshold T0 and a PDSCH result comprising a cyclic redundancy check (CRC) pass rate of 100%. The UE may terminate the measurement of the channel condition based on any of the aspects described in connection with FIG. 4.

At 612, the UE 602 may trigger a measurement across the plurality of antennas. In some aspects, the UE may trigger a measurement across the plurality of antennas in response to an imbalance of the channel condition between two active antennas, from the plurality of antennas, being greater than a fourth threshold T3. In some aspects, the plurality of antennas may comprise four antennas, wherein the measurement is triggered across the four antennas. In some aspects, the UE may trigger the measurement across the plurality of antennas in response to the channel condition across a first pair of active antennas, from the plurality of antennas, is less than a second threshold (T1). In some aspects, the plurality of antennas may comprise four antennas, wherein the measurement is triggered across the four antennas. The UE may trigger the measurement based on any of the aspects described in connection with FIG. 4. The UE may determine whether a second pair of antennas have channel conditions greater than the second threshold. The UE may determine whether the second pair of antennas have channel conditions greater than the second threshold in response to the channel condition across the first pair of active antennas being less than the second threshold (T1). In some aspects, the UE may switch to the second pair of antennas. The UE may switch to the second pair of antennas, from the plurality of antennas, in response to the second pair of antennas comprising the channel conditions greater than the second threshold.

At 614, the UE 602 may activate all antennas of the plurality of antennas to receive downlink signaling. The UE may activate all antennas of the plurality of antennas to receive downlink signaling in response to the channel condition of the plurality of antennas being less than a third threshold (T2). The UE may activate all the antennas to receive downlink signaling based on any of the aspects described in connection with FIG. 4.

At 616, the UE 602 may dynamically select at least one antenna from the plurality of antennas based on the channel condition. The UE may dynamically select the at least one antenna from the plurality of antennas based on the channel condition while in a RRC idle mode. The UE may dynamically select at least one antenna based on any of the aspects described in connection with FIG. 4.

At 618, the UE 602 may communicate with the base station 604 using the dynamically selected at least one antenna.

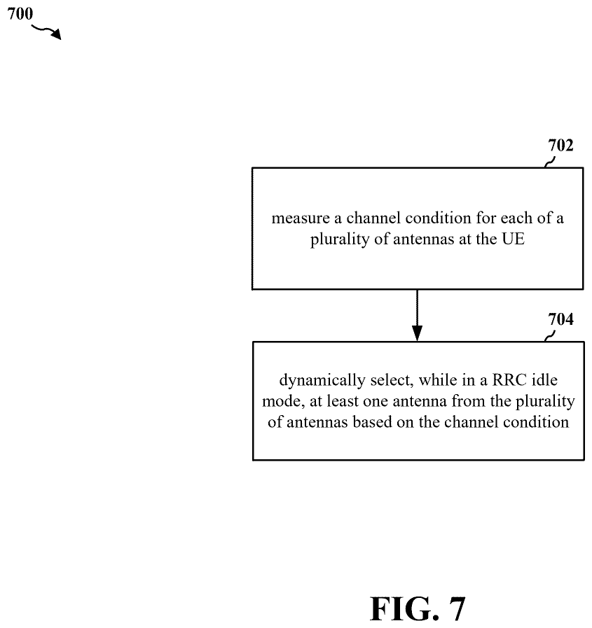

FIG. 7 is a flowchart 700 of a method of wireless communication. The method may be performed by a UE (e.g., the UE 104; the apparatus 904). One or more of the illustrated operations may be omitted, transposed, or contemporaneous. The method may allow a UE to select an antenna while in RRC idle mode.

At 702, the UE may measure a channel condition for each of a plurality of antennas at the UE. For example, 702 may be performed by selection component 198 of apparatus 904. In some aspects, the channel condition for each of the plurality of antennas may be measured during a measurement period. The measurement of the channel condition may be based on at least one threshold. In some aspects, the at least one threshold may be configurable or pre-configured. The UE may measure the channel condition based on any of the aspects described in connection with FIG. 4.

At 704, the UE may dynamically select at least one antenna from the plurality of antennas based on the channel condition. For example, 704 may be performed by selection component 198 of apparatus 904. The UE may dynamically select the at least one antenna from the plurality of antennas based on the channel condition, while in a RRC idle mode. The UE may dynamically select at least one antenna based on any of the aspects described in connection with FIG. 4.

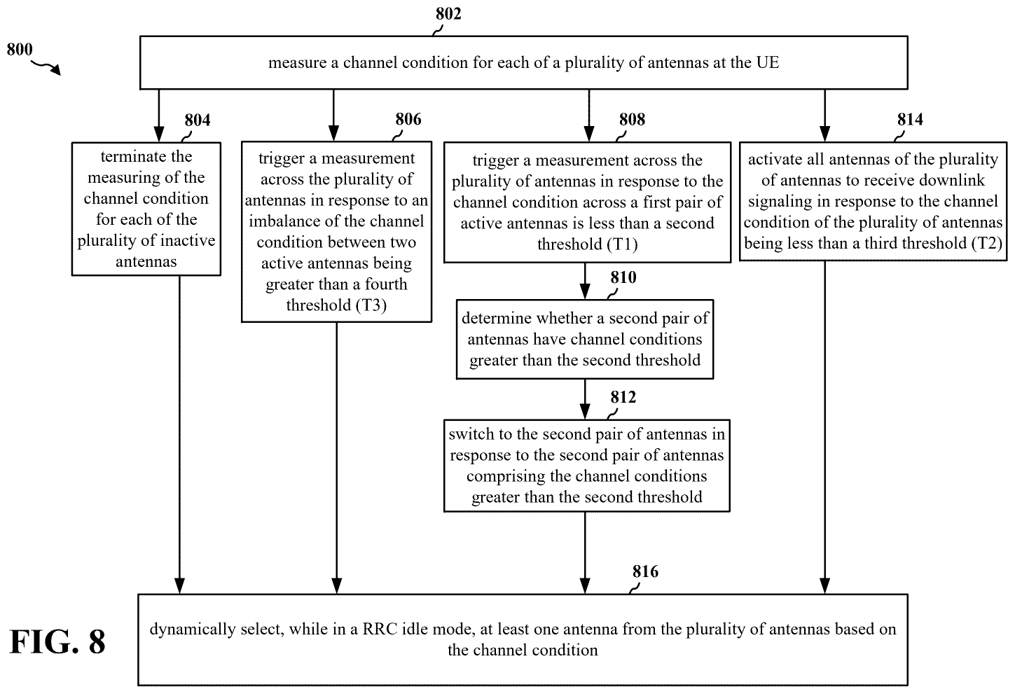

FIG. 8 is a flowchart 800 of a method of wireless communication. The method may be performed by a UE (e.g., the UE 104; the apparatus 904). One or more of the illustrated operations may be omitted, transposed, or contemporaneous. The method may allow a UE to select an antenna while in RRC idle mode.

At 802, the UE may measure a channel condition for each of a plurality of antennas at the UE. For example, 802 may be performed by selection component 198 of apparatus 904. In some aspects, the channel condition for each of the plurality of antennas may be measured during a measurement period. The measurement of the channel condition may be based on at least one threshold. In some aspects, the at least one threshold may be configurable or pre-configured. The UE may measure the channel condition based on any of the aspects described in connection with FIG. 4. At 804, the UE may terminate the measuring of the channel conditions for each of the plurality of inactive antennas. For example, 804 may be performed by selection component 198 of apparatus 904. The UE may terminate the measuring of the channel conditions for each of the plurality of inactive antennas in response to the channel condition on two active antennas, from the plurality of antennas, being greater than a first threshold T0 and a PDSCH result comprising a CRC pass rate of 100%. The UE may terminate the measuring of the channel condition based on any of the aspects described in connection with FIG. 4.

At 806, the UE may trigger a measurement across the plurality of antennas. For example, 806 may be performed by selection component 198 of apparatus 904. The UE may trigger a measurement across the plurality of antennas in response to an imbalance of the channel condition between two active antennas, from the plurality of antennas, being greater than a fourth threshold T3. In some aspects, the plurality of antennas may comprise four antennas, wherein the measurement is triggered across the four antennas. The UE may trigger the measurement based on any of the aspects described in connection with FIG. 4.

At 808, the UE may trigger a measurement across the plurality of antennas. For example, 806 may be performed by selection component 198 of apparatus 904. The UE may trigger the measurement across the plurality of antennas in response to the channel condition across a first pair of active antennas, from the plurality of antennas, is less than a second threshold (T1). In some aspects, the plurality of antennas may comprise four antennas, wherein the measurement is triggered across the four antennas. The UE may trigger the measurement based on any of the aspects described in connection with FIG. 4.

At 810, the UE may determine whether a second pair of antennas have channel conditions greater than the second threshold. For example, 806 may be performed by selection component 198 of apparatus 904.

At 812, the UE may switch to the second pair of antennas. For example, 806 may be performed by selection component 198 of apparatus 904. The UE may switch to the second pair of antennas, from the plurality of antennas, in response to the second pair of antennas comprising the channel conditions greater than the second threshold. At 814, the UE may activate all antennas of the plurality of antennas to receive downlink signaling. For example, 806 may be performed by selection component 198 of apparatus 904. The UE may activate all antennas of the plurality of antennas to receive downlink signaling in response to the channel condition of the plurality of antennas being less than a third threshold (T2).

At 816, the UE may dynamically select at least one antenna from the plurality of antennas based on the channel condition. For example, 816 may be performed by selection component 198 of apparatus 904. The UE may dynamically select the at least one antenna from the plurality of antennas based on the channel condition while in a RRC idle mode. The UE may dynamically select at least one antenna based on any of the aspects described in connection with FIG. 4.

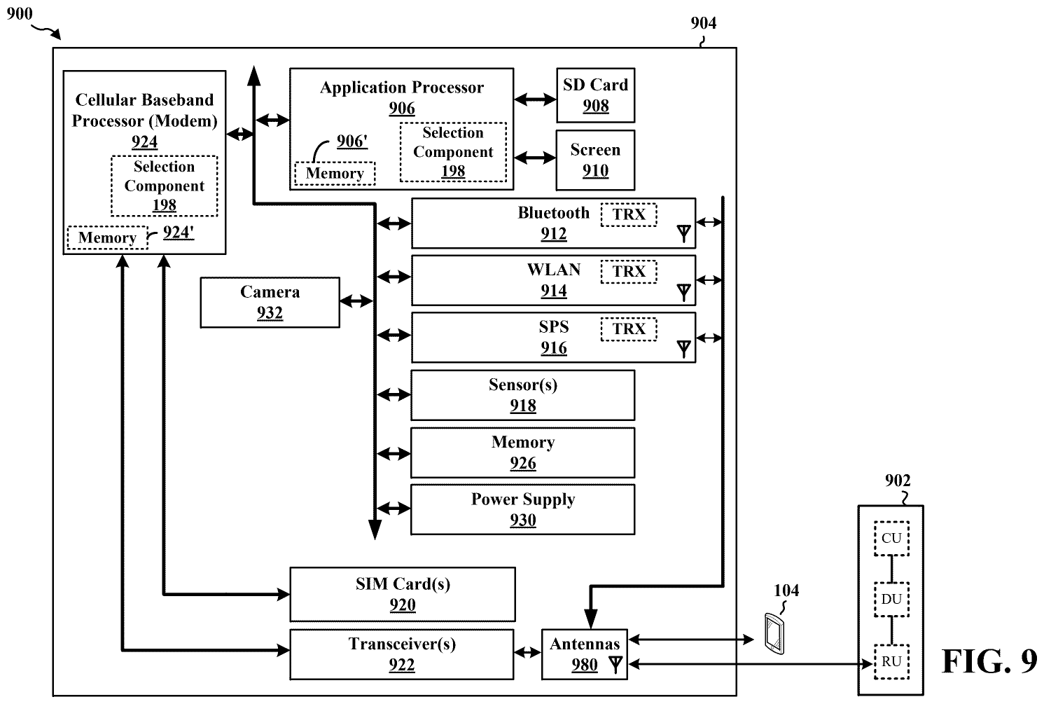

FIG. 9 is a diagram 900 illustrating an example of a hardware implementation for an apparatus 904. The apparatus 904 may be a UE, a component of a UE, or may implement UE functionality. In some aspects, the apparatus 904 may include a cellular baseband processor 924 (also referred to as a modem) coupled to one or more transceivers 922 (e.g., cellular RF transceiver). The cellular baseband processor 924 may include on-chip memory 924′. In some aspects, the apparatus 904 may further include one or more subscriber identity modules (SIM) cards 920 and an application processor 906 coupled to a secure digital (SD) card 908 and a screen 910. The application processor 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor 924 communicates through the transceiver(s) 922 via one or more antennas 980 with the UE 104 and/or with an RU associated with a network entity 902. The cellular baseband processor 924 and the application processor 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the memory 360 and/or at least one of the TX processor 368, the RX processor 356, and the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see 350 of FIG. 3) and include the additional modules of the apparatus 904.

As discussed supra, the component 198 is configured to measure a channel condition for each of a plurality of antennas at the UE; and dynamically select, while in a RRC idle mode, at least one antenna from the plurality of antennas based on the channel condition. The component 198 may be within the cellular baseband processor 924, the application processor 906, or both the cellular baseband processor 924 and the application processor 906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 904 may include a variety of components configured for various functions. In one configuration, the apparatus 904, and in particular the cellular baseband processor 924 and/or the application processor 906, includes means for measuring a channel condition for each of a plurality of antennas at the UE. The apparatus includes means for dynamically selecting, while in a RRC idle mode, at least one antenna from the plurality of antennas based on the channel condition. The apparatus further includes means for terminating the measuring of the channel condition for each of the plurality of antennas in response to the channel condition on two active antennas being greater than a first threshold (T0) and a PDSCH result comprises a CRC pass rate of 100%. The apparatus further includes means for triggering a measurement across the plurality of antennas in response to an imbalance of the channel condition between two active antennas being greater than a fourth threshold (T3). The apparatus further includes means for triggering a measurement across the plurality of antennas in response to the channel condition across a first pair of active antennas is less than a second threshold (T1). The apparatus further includes means for determining whether a second pair of antennas have channel conditions greater than the second threshold. The apparatus further includes means for switching to the second pair of antennas in response to the second pair of antennas comprising the channel conditions greater than the second threshold. The apparatus further includes means for activating all antennas of the plurality of antennas to receive downlink signaling in response to the channel condition of the plurality of antennas being less than a third threshold (T2). The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

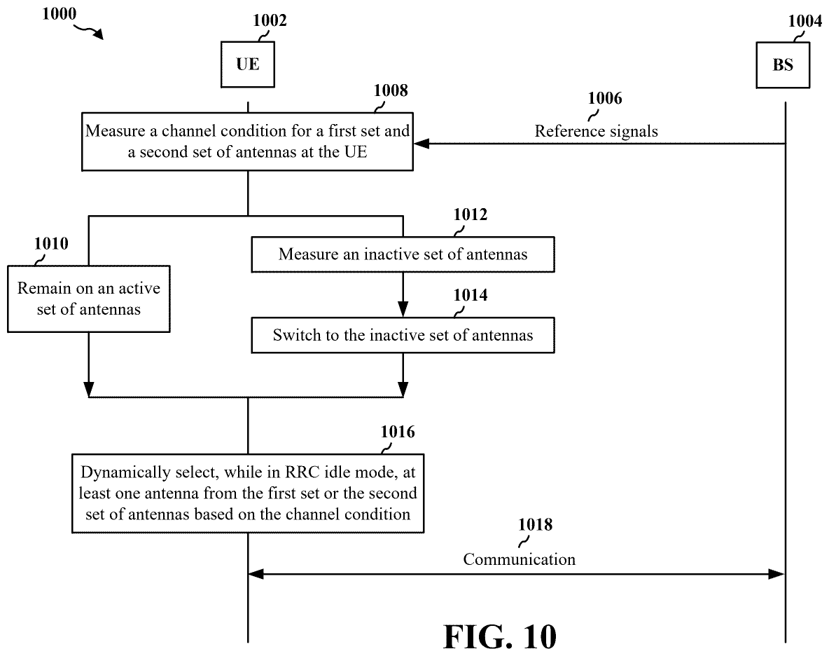

FIG. 10 is a call flow diagram 1000 of signaling between a UE 1002 and a base station 1004. The base station 1004 may be configured to provide at least one cell. The UE 1002 may be configured to communicate with the base station 1004. For example, in the context of FIG. 1, the base station 1004 may correspond to base station 102. Further, a UE 1002 may correspond to at least UE 104. In another example, in the context of FIG. 3, the base station 1004 may correspond to base station 310 and the UE 1002 may correspond to UE 350.

At 1006, the base station 1004 may transmit one or more reference signals to the UE 1002. The UE 1002, at 1008, may measure a channel condition for a first set of antennas and a second set of antennas at the UE. In some aspects, the first set of antennas may comprise two antennas and the second set of antennas may comprise two antennas. At least one of the first set of antennas or the second set of antennas may be inactive, wherein measurement of the channel condition occurs while the at least one of the first set of antennas or the second set of antennas is inactive. In some aspects, the measurement of the channel condition of an inactive set of the at least one of the first set of antennas or the second set of antennas may be during a DRX off period. Each of the first set of antennas or the second set of antennas may be measured at least once during one or more DRX periods. In some aspects, the one or more DRX periods may comprise one or more I-DRX periods. In some aspects, measurement of the first set of antennas or the second set of antennas may be triggered once every I-DRX period or multiple I-DRX periods. A measurement rate may be based on an RSRP level of an active set of the first set of antennas or the second set of antennas. The UE may measure the channel condition based on any of the aspects described in connection with FIG. 5.

At 1010, the UE 1002 may remain on an active set of antennas from the first set of antennas or the second set of antennas. The UE may remain on an active set of antennas from the first set of antennas or the second set of antennas in response to the channel condition being greater than a first threshold (T0) and a PDSCH result comprising a CRC pass rate of 100%. The UE may remain on the active set of antennas based on any of the aspects described in connection with FIG. 5.

At 1012, the UE 1002 may measure an inactive set of antennas. The UE may measure the inactive set of antennas in response to at least the channel condition of an active set of antennas being less than a first threshold (T0). The UE may measure the inactive set of antennas based on any of the aspects described in connection with FIG. 5.

At 1014, the UE 1002 may switch to the inactive set of antennas. The UE may switch to the inactive set of antennas if the channel condition of the inactive set of antennas is greater than T0 or the active set of antennas. The UE may switch to the inactive set of antennas based on any of the aspects described in connection with FIG. 5.

At 1016, the UE 1002 may dynamically select at least one antenna from the first set of antennas or the second set of antennas. The UE may dynamically select at least one antenna from the first set of antennas or the second set of antennas while in a RRC idle mode. The UE may dynamically select at least one antenna from the first set of antennas or the second set of antennas, while in the RRC idle mode, based on the channel conditions. In some aspects, the first set of antennas may comprise one antenna and the second set of antennas may comprise three antennas. In such instances, an antenna having a highest channel condition may be selected to comprise the first set of antennas, and remaining antennas may be selected to comprise the second set of antennas. In some aspects, the channel condition of the second set of antennas may be periodically measured to determine an antenna from the second set of antennas having a highest channel condition. The UE may dynamically select at least one antenna based on any of the aspects described in connection with FIG. 5.

At 1018, the UE 1002 may communicate with the base station 1004 using the dynamically selected at least one antenna.

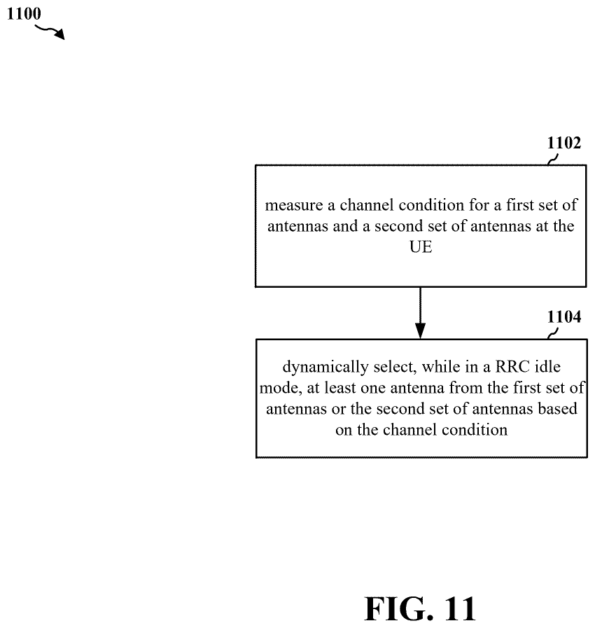

FIG. 11 is a flowchart 1100 of a method of wireless communication. The method may be performed by a UE (e.g., the UE 104; the apparatus 1304). One or more of the illustrated operations may be omitted, transposed, or contemporaneous. The method may allow a UE to select an antenna while in RRC idle mode.

At 1102, the UE may measure a channel condition for a first set of antennas and a second set of antennas at the UE. For example, 1102 may be performed by selection component 198 of apparatus 1304. In some aspects, the first set of antennas may comprise two antennas and the second set of antennas may comprise two antennas. At least one of the first set of antennas or the second set of antennas may be inactive, wherein measurement of the channel condition occurs while the at least one of the first set of antennas or the second set of antennas is inactive. In some aspects, the measurement of the channel condition of an inactive set of the at least one of the first set of antennas or the second set of antennas may be during a DRX off period. Each of the first set of antennas or the second set of antennas may be measured at least once during one or more DRX periods. In some aspects, the one or more DRX periods may comprise one or more idle DRX (I-DRX) periods. The UE may measure the channel condition based on any of the aspects described in connection with FIG. 5.

At 1104, the UE may dynamically select at least one antenna from the first set of antennas or the second set of antennas. For example, 1104 may be performed by selection component 198 of apparatus 1304. The UE may dynamically select at least one antenna from the first set of antennas or the second set of antennas while in a RRC idle mode. The UE may dynamically select at least one antenna from the first set of antennas or the second set of antennas, while in the RRC idle mode, based on the channel conditions. In some aspects, the first set of antennas may comprise one antenna and the second set of antennas may comprise three antennas. In such instances, an antenna having a highest channel condition may be selected to comprise the first set of antennas, and remaining antennas may be selected to comprise the second set of antennas. In some aspects, the channel condition of the second set of antennas may be periodically measured to determine an antenna from the second set of antennas having a highest channel condition. The UE may dynamically select at least one antenna based on any of the aspects described in connection with FIG. 5.

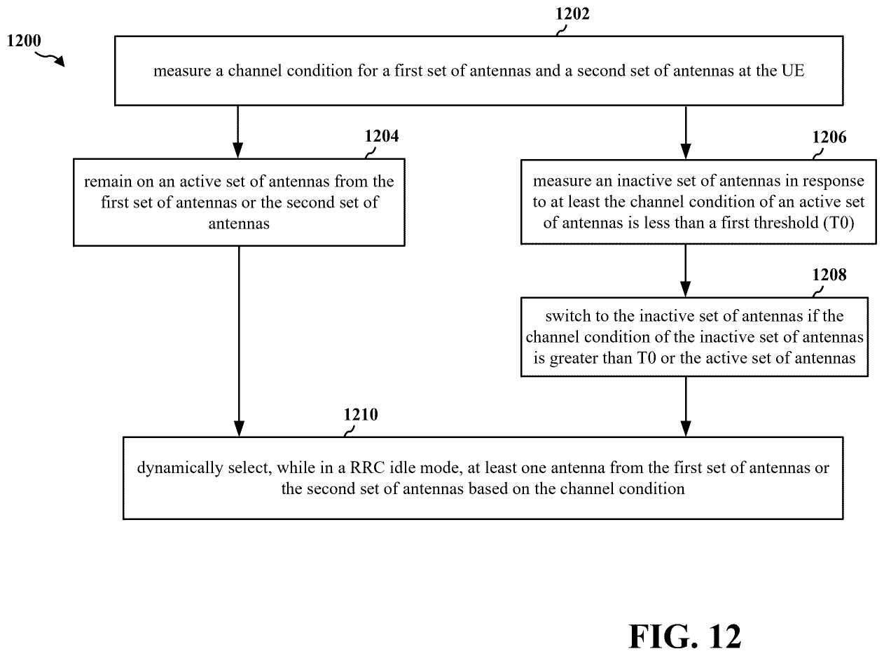

FIG. 12 is a flowchart 1200 of a method of wireless communication. The method may be performed by a UE (e.g., the UE 104; the apparatus 1304). One or more of the illustrated operations may be omitted, transposed, or contemporaneous. The method may allow a UE to select an antenna while in RRC idle mode.

At 1202, the UE may measure a channel condition for a first set of antennas and a second set of antennas at the UE. For example, 1202 may be performed by selection component 198 of apparatus 1304. In some aspects, the first set of antennas may comprise two antennas and the second set of antennas may comprise two antennas. At least one of the first set of antennas or the second set of antennas may be inactive, wherein measurement of the channel condition occurs while the at least one of the first set of antennas or the second set of antennas is inactive. In some aspects, the measurement of the channel condition of an inactive set of the at least one of the first set of antennas or the second set of antennas may be during a DRX off period. Each of the first set of antennas or the second set of antennas may be measured at least once during one or more DRX periods. In some aspects, the one or more DRX periods may comprise one or more I-DRX periods. In some aspects, measurement of the first set of antennas or the second set of antennas may be triggered once every I-DRX period or multiple I-DRX periods. A measurement rate may be based on an RSRP level of an active set of the first set of antennas or the second set of antennas. The UE may measure the channel condition based on any of the aspects described in connection with FIG. 5.

At 1204, the UE may remain on an active set of antennas from the first set of antennas or the second set of antennas. For example, 1204 may be performed by selection component 198 of apparatus 1304. The UE may remain on an active set of antennas from the first set of antennas or the second set of antennas in response to the channel condition being greater than a first threshold (T0) and a PDSCH result comprising a CRC pass rate of 100%. The UE may remain on the active set of antennas based on any of the aspects described in connection with FIG. 5.

At 1206, the UE may measure an inactive set of antennas. For example, 1206 may be performed by selection component 198 of apparatus 1304. The UE may measure the inactive set of antennas in response to at least the channel condition of an active set of antennas being less than a first threshold (T0). The UE may measure the inactive set of antennas based on any of the aspects described in connection with FIG. 5.

At 1208, the UE may switch to the inactive set of antennas. For example, 1208 may be performed by selection component 198 of apparatus 1304. The UE may switch to the inactive set of antennas if the channel condition of the inactive set of antennas is greater than TO or the active set of antennas. The UE may switch to the inactive set of antennas based on any of the aspects described in connection with FIG. 5.

At 1210, the UE may dynamically select at least one antenna from the first set of antennas or the second set of antennas. For example, 1210 may be performed by selection component 198 of apparatus 1304. The UE may dynamically select at least one antenna from the first set of antennas or the second set of antennas while in a RRC idle mode. The UE may dynamically select at least one antenna from the first set of antennas or the second set of antennas, while in the RRC idle mode, based on the channel conditions. In some aspects, the first set of antennas may comprise one antenna and the second set of antennas may comprise three antennas. In such instances, an antenna having a highest channel condition may be selected to comprise the first set of antennas, and remaining antennas may be selected to comprise the second set of antennas. In some aspects, the channel condition of the second set of antennas may be periodically measured to determine an antenna from the second set of antennas having a highest channel condition. The UE may dynamically select at least one antenna based on any of the aspects described in connection with FIG. 5.

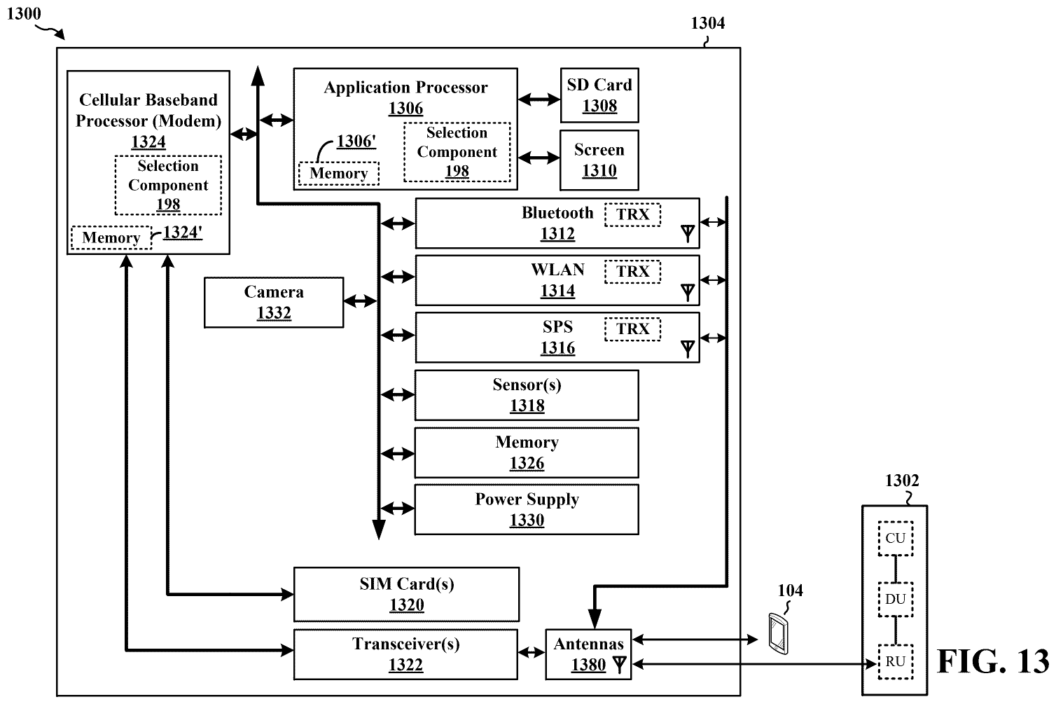

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to measure a channel condition for a first set of antennas and a second set of antennas at the UE; and dynamically select, while in a RRC idle mode, at least one antenna from the first set of antennas or the second set of antennas based on the channel condition. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for measuring a channel condition for a first set of antennas and a second set of antennas at the UE. The apparatus includes means for dynamically selecting, while in a RRC idle mode, at least one antenna from the first set of antennas or the second set of antennas based on the channel condition. The apparatus further includes means for remaining on an active set of antennas from the first set of antennas or the second set of antennas in response to the channel condition being greater than a first threshold (T0) and a PDSCH result comprising a CRC pass rate of 100%. The apparatus further includes means for measuring an inactive set of antennas in response to at least the channel condition of an active set of antennas is less than a first threshold (TO). The apparatus further includes means for switching to the inactive set of antennas if the channel condition of the inactive set of antennas is greater than TO or the active set of antennas. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising measuring a channel condition for each of a plurality of antennas at the UE; and dynamically selecting, while in a RRC idle mode, at least one antenna from the plurality of antennas based on the channel condition.

Aspect 2 is the method of aspect 1, further includes that the channel condition for each of the plurality of antennas is measured during a measurement period, wherein measurement of the channel condition is based on at least one threshold.

Aspect 3 is the method of any of aspects 1 and 2, further includes that the at least one threshold is configurable or pre-configured.

Aspect 4 is the method of any of aspects 1-3, further including terminating the measurement of the channel condition for each of the plurality of inactive antennas in response to the channel condition on two active antennas being greater than a first threshold (T0) and a PDSCH result comprises a CRC pass rate of 100%.

Aspect 5 is the method of any of aspects 1-4, further including triggering the measurement across the plurality of antennas in response to an imbalance of the channel condition between two active antennas being greater than a fourth threshold (T3).

Aspect 6 is the method of any of aspects 1-5, further includes that the plurality of antennas comprises four antennas, wherein the measurement is triggered across the four antennas.

Aspect 7 is the method of any of aspects 1-6, further including triggering the measurement across the plurality of antennas in response to the channel condition across a first pair of active antennas is less than a second threshold (T1); and determining whether a second pair of antennas have channel conditions greater than the second threshold.

Aspect 8 is the method of any of aspects 1-7, further includes that the plurality of antennas comprises four antennas.

Aspect 9 is the method of any of aspects 1-8, further including switching to the second pair of antennas in response to the second pair of antennas comprising the channel conditions greater than the second threshold.

Aspect 10 is the method of any of aspects 1-9, further including activating all antennas of the plurality of antennas to receive downlink signaling in response to the channel condition of the plurality of antennas being less than a third threshold (T2).

Aspect 11 is an apparatus for wireless communication at a UE including at least one processor coupled to a memory and at least one transceiver, the at least one processor configured to implement any of Aspects 1-10.

Aspect 12 is an apparatus for wireless communication at a UE including means for implementing any of Aspects 1-10.

Aspect 13 is a computer-readable medium storing computer executable code, where the code when executed by a processor causes the processor to implement any of Aspects 1-10.

Aspect 14 is a method of wireless communication at a UE comprising measuring a channel condition for a first set of antennas and a second set of antennas at the UE; and dynamically selecting, while in a RRC idle mode, at least one antenna from the first set of antennas or the second set of antennas based on the channel condition.

Aspect 15 is the method of aspect 14, further includes that the first set of antennas comprises two antennas and the second set of antennas comprises two antennas.

Aspect 16 is the method of any of aspects 14 and 15, further includes that at least one of the first set of antennas or the second set of antennas is inactive, wherein measurement of the channel condition occurs while the at least one of the first set of antennas or the second set of antennas is inactive.

Aspect 17 is the method of any of aspects 14-16, further includes that the measurement of the channel condition of an inactive set of the at least one of the first set of antennas or the second set of antennas is during a DRX off period.

Aspect 18 is the method of any of aspects 14-17, further includes that each of the first set of antennas or the second set of antennas is measured at least once during one or more DRX periods.

Aspect 19 is the method of any of aspects 14-18, further includes that the one or more DRX periods comprise one or more I-DRX periods, wherein measurement of the first set of antennas or the second set of antennas is triggered once every I-DRX period or multiple I-DRX periods, wherein a measurement rate is based on an RSRP level of an active set of the first set of antennas or the second set of antennas.

Aspect 20 is the method of any of aspects 14-19, further including remaining on an active set of antennas from the first set of antennas or the second set of antennas in response to the channel condition being greater than a first threshold (T0) and a PDSCH result comprising a CRC pass rate of 100%.

Aspect 21 is the method of any of aspects 14-20, further including measuring an inactive set of antennas in response to at least the channel condition of an active set of antennas is less than a first threshold (T0); and switching to the inactive set of antennas if the channel condition of the inactive set of antennas is greater than TO or the active set of antennas.

Aspect 22 is the method of any of aspects 14-21, further includes that the first set of antennas comprises one antenna and the second set of antennas comprises three antennas, wherein an antenna having a highest channel condition is selected to comprise the first set of antennas, and remaining antennas are selected to comprise the second set of antennas.

Aspect 23 is the method of any of aspects 14-22, further includes that the channel condition of the second set of antennas is periodically measured to determine an antenna from the second set of antennas having a highest channel condition.

Aspect 24 is an apparatus for wireless communication at a UE including at least one processor coupled to a memory and at least one transceiver, the at least one processor configured to implement any of Aspects 14-23.

Aspect 25 is an apparatus for wireless communication at a UE including means for implementing any of Aspects 14-23.

Aspect 26 is a computer-readable medium storing computer executable code, where the code when executed by a processor causes the processor to implement any of Aspects 14-23.

1. An apparatus for wireless communication at a user equipment (UE), comprising:
a memory; and
at least one processor coupled to the memory and, based at least in part on information stored in the memory, the at least one processor is configured to:
measure a channel condition for each of a plurality of antennas at the UE; and
dynamically select, while in a radio resource control (RRC) idle mode, at least one antenna from the plurality of antennas based on the channel condition.

2. (canceled)

3. The apparatus of claim 1, wherein the channel condition for each of the plurality of antennas is measured during a measurement period, wherein measurement of the channel condition is based on at least one threshold.

4. (canceled)

5. The apparatus of claim 3, wherein the at least one processor is configured to:
terminate the measurement of the channel condition for each of a plurality of inactive antennas in response to the channel condition on two active antennas being greater than a first threshold (T0) and a physical downlink shared channel (PDSCH) result comprises a cyclic redundancy check (CRC) pass rate of 100%.

6. The apparatus of claim 3, wherein the at least one processor is configured to:
trigger the measurement across the plurality of antennas in response to an imbalance of the channel condition between two active antennas being greater than a fourth threshold (T3).

7. The apparatus of claim 6, wherein the plurality of antennas comprises four antennas, wherein the measurement is triggered across the four antennas.

8. The apparatus of claim 3, wherein the at least one processor is configured to:
trigger the measurement across the plurality of antennas in response to the channel condition across a first pair of active antennas is less than a second threshold (T1); and
determine whether a second pair of antennas have channel conditions greater than the second threshold.

9. The apparatus of claim 8, wherein the plurality of antennas comprises four antennas; and
wherein the at least one processor is configured to switch to the second pair of antennas in response to the second pair of antennas comprising the channel conditions greater than the second threshold.

10. (canceled)

11. The apparatus of claim 3, wherein the at least one processor is configured to:
activate all antennas of the plurality of antennas to receive downlink signaling in response to the channel condition of the plurality of antennas being less than a third threshold (T2).

12. A method of wireless communication at user equipment (UE), comprising:
measuring a channel condition for each of a plurality of antennas at the UE; and
dynamically selecting, while in a radio resource control (RRC) idle mode, at least one antenna from the plurality of antennas based on the channel condition.

13. The method of claim 12, wherein the channel condition for each of the plurality of antennas is measured during a measurement period, wherein measurement of the channel condition is based on at least one threshold.

14. The method of claim 13, further comprising:
terminating the measurement of the channel condition for each of a plurality of inactive antennas in response to the channel condition on two active antennas being greater than a first threshold (T0) and a physical downlink shared channel (PDSCH) result comprises a cyclic redundancy check (CRC) pass rate of 100%.

15. (canceled)

16. The method of claim 13, further comprising:
triggering the measurement across the plurality of antennas in response to the channel condition across a first pair of active antennas is less than a second threshold (T1); and
determining whether a second pair of antennas have channel conditions greater than the second threshold.

17. An apparatus for wireless communication at a user equipment (UE), comprising:
a memory; and
at least one processor coupled to the memory and, based at least in part on information stored in the memory, the at least one processor is configured to:
measure a channel condition for a first set of antennas and a second set of antennas at the UE; and
dynamically select, while in a radio resource control (RRC) idle mode, at least one antenna from the first set of antennas or the second set of antennas based on the channel condition.

18. (canceled)

19. The apparatus of claim 17, wherein the first set of antennas comprises two antennas and the second set of antennas comprises two antennas.

20. The apparatus of claim 19, wherein at least one of the first set of antennas or the second set of antennas is inactive, wherein measurement of the channel condition occurs while the at least one of the first set of antennas or the second set of antennas is inactive.

21. (canceled)

22. The apparatus of claim 19, wherein each of the first set of antennas or the second set of antennas is measured at least once during one or more DRX periods.

23. (canceled)

24. The apparatus of claim 19, wherein the at least one processor is configured to:
remain on an active set of antennas from the first set of antennas or the second set of antennas in response to the channel condition being greater than a first threshold (T0) and a physical downlink shared channel (PDSCH) result comprising a cyclic redundancy check (CRC) pass rate of 100%.

25. The apparatus of claim 19, wherein the at least one processor is configured to:
measure an inactive set of antennas in response to at least the channel condition of an active set of antennas is less than a first threshold (T0); and
switch to the inactive set of antennas if the channel condition of the inactive set of antennas is greater than TO or the active set of antennas.

26. The apparatus of claim 17, wherein the first set of antennas comprises one antenna and the second set of antennas comprises three antennas, wherein an antenna having a highest channel condition is selected to comprise the first set of antennas, and remaining antennas are selected to comprise the second set of antennas.

27. (canceled)

28. (canceled)

29. (canceled)

30. (canceled)
